(19) United States
(12) Patent Application Publication
(10) Pub. No.: US 2022/0117167 A1
(43) Pub. Date: Apr. 21, 2022

(54) ATRIUM HYBRID GREENHOUSE

(71) Applicant: Carlos BISHOP, Escondido, CA (US)

(72) Inventor: Carlos BISHOP, Escondido, CA (US)

(21) Appl. No.: 17/071,706

(22) Filed: Oct. 15, 2020

(51) Int. Cl. A01G 9/20; E04B 1/19; A01G 9/24; E04B 2/92

(52) U.S. Cl. CPC A01G 9/20; E04B 1/19; E04B 2001/199; E04B 2/92; A01G 9/24

(57) ABSTRACT

An atrium hybrid greenhouse. The greenhouse employs the skeleton structure of columns, girders, and joists of an industrial metal building on which are spaced external and internal walls, and spaced roof and ceiling. The spaced walls form a wall cavity therebetween, and the roof and ceiling form a ceiling cavity therebetween. A radius cave channel is used to connect the wall cavity and the ceiling cavity for fluid flow therebetween. The external and internal wall and roof/ceiling panels are formed of relatively stiff light transmissive material such as polycarbonate. The formed cavity also provides insulation value.

### FIELD OF THE INVENTION

This invention relates generally to greenhouse or other exterior transparent structures and more particularly, to apparatus for converting a basic joist and girder industrial metal building to a functional greenhouse for effective use in cold climates, high heat, or high humidity conditions, among others.

### BACKGROUND OF THE INVENTION

There are many greenhouse structures. There are many basic warehouse or industrial building structures. Generally, these two types of structures are not compatible. Industrial metal buildings are not conducive to the high levels of interior illumination that are required for maximum daylight transmission coupled with the heat/cold insulation that may be required for growing plants in climates which may experience high heat as well as significant cold temperatures.

In general, buildings designed to function as greenhouses do not include sufficient structure to prevent overheating of the interior in hot climates, such as deserts, nor are they designed to accommodate winter-like weather. Weather conditions which result in high humidity within a building can cause build-up of condensation, mold, mildew, and other types of fungi.

### SUMMARY OF EMBODIMENTS OF THE INVENTION

It is a purpose of embodiments of this invention to modify a basic industrial metal building, warehouse, or other conventionally built structure of any size to enable it to function as an all-weather, sealed, laboratory environment with day lighting control, greenhouse.

The conventional metal column, girder, and joist industrial building structure is the basis for the greenhouse of this concept. To state it in another way, the starting point for the embodiments disclosed is the structural skeleton of an industrial metal building. Such buildings also may employ girts to provide lateral support to the wall panels.

As an option, for security reasons, the external walls may be solid and opaque, to any desired height from the ground level. Typically, the ground level is a foundation/concrete pad on which the building is constructed and to which it is anchored. From the pad, or above the optional solid wall, is the upper wall which extends to the roof. The upper wall may be made of single or multiple layer, standing seam polycarbonate material, glass, or any known relatively rigid, light transmitting material.

The roof of a standard metal building is typically, as an example, corrugated metal or fiberglass, supported by beams or a truss structure. In cold climates it would typically have sufficient strength to withstand a normal amount of snow and would have a pitch of sufficient steepness or angle to prevent a large accumulation of snow.

As further modified in accordance with the concept described herein, the roof, similar to the walls, would be made of single or multiple layer, standing seam polycarbonate material or any known relatively rigid light transmitting material. However, both the exterior wall and the roof, in accordance with this concept, are double paned. That is, the exterior wall is formed of two spaced light transmissive panels or sheets and the roof/ceiling is also made of two spaced light transmissive panels or sheets which are mounted to the supporting members of the structure. At the upper corner where the dual wall panels meet the dual roof panels, the wall chamber and the roof/ceiling chamber are in fluid communication. While the external and internal panels are secured to supporting structural columns and girts in spaced relationship to form a cavity or channel between them, the supporting structure is formed to permit fluid flow through the channel, laterally and vertically. The same is true for the similarly formed roof/ceiling cavity or channel, to permit fluid flow through the entire roof structure.

Thus, the wall and the roof enable heated or cooling air to flow through the walls and the roof/ceiling to maintain a controlled temperature and environment within the building. As an option, the wall chamber and the roof chamber may be sealed from each other. In addition to heating or cooling, the air within the walls and the roof can be adjusted for proper humidity so that moisture, and resulting mold, does not form within the wall and roof double paneled spaces. In some instances, the fluid flowing in the wall and ceiling chambers may be a gas.

The formed cavity also provides insulation value.

### BRIEF DESCRIPTION OF THE DRAWING

The objects, advantages, and features of the invention embodiments disclosed herein will be more easily understood from the following detailed description, when read in conjunction with the accompanying drawing, in which:

FIG. 1 is a perspective view of a hybrid atrium greenhouse structure in accordance with an embodiment of the invention;

FIG. 2 is a partial perspective view of a corner of a typical industrial metal building structure;

FIG. 3 is a sectional view of the greenhouse structure of FIG. 1;

FIG. 4 is a phantom perspective view of a segment of the FIG. 1 structure;

FIG. 5 is an enlarged sectional view of the corner transition from the wall to roof channels;

FIG. 6 is an enlarged sectional segment of a wall channel; and

FIG. 7 is an enlarged sectional segment of an alternative embodiment of the wall of FIG. 1 mounted to its pad.

### DETAILED DESCRIPTION OF EMBODIMENTS OF THE INVENTION

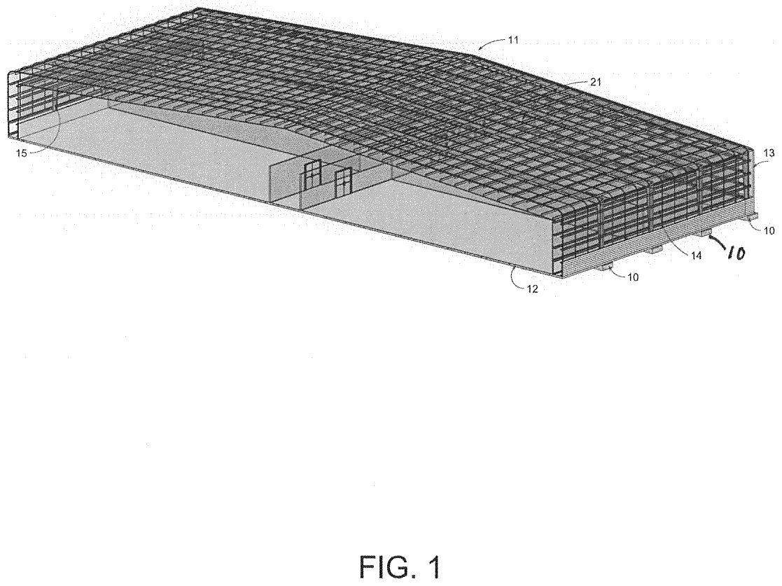

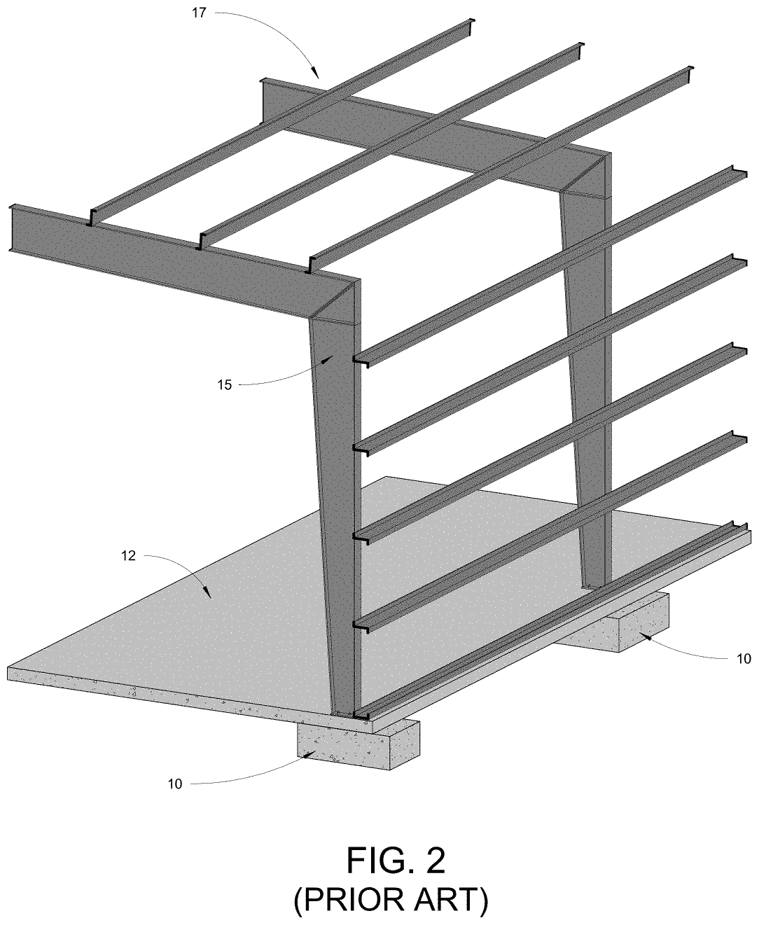

With reference now to the drawing, and more particularly to FIGS. 1 and 2 thereof, hybrid greenhouse 11 converted from an industrial metal building is shown. The structure typically sits on a concrete foundation or pad 12 and includes walls 13 having external weatherized panels 14 mounted to upright support columns 15. The upright support columns may be secured directly to the pad or to a horizontal plate or beam which is itself secured to the pad. The pad may be further supported on footings 10.

At the top of walls 13 may be horizontal beams or girders to which support columns 15 and the roof structure 17 are mounted. The roof of an industrial metal building is typically comprised of a known truss structure 21, of which there are many forms and of which structure 17 is a part. The outer surface may be corrugated metal or other relatively strong and relatively rigid panels mounted on top of roof structure 21.

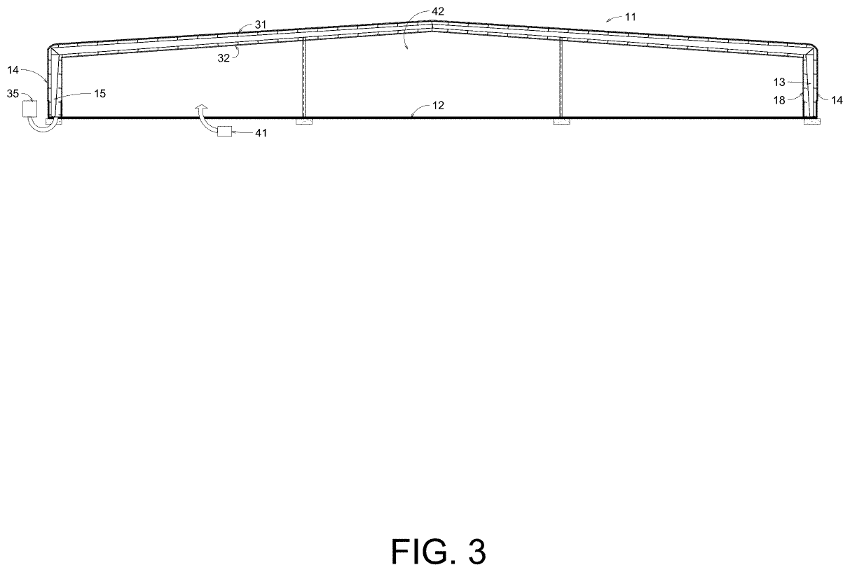

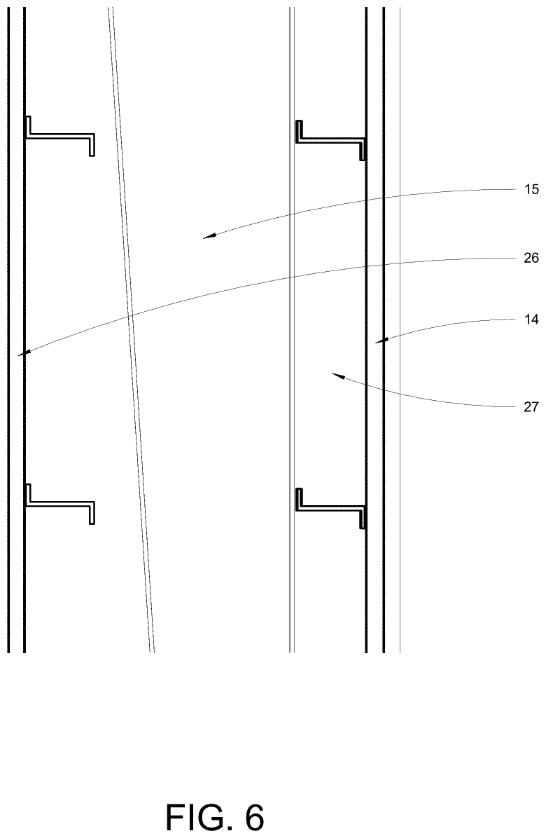

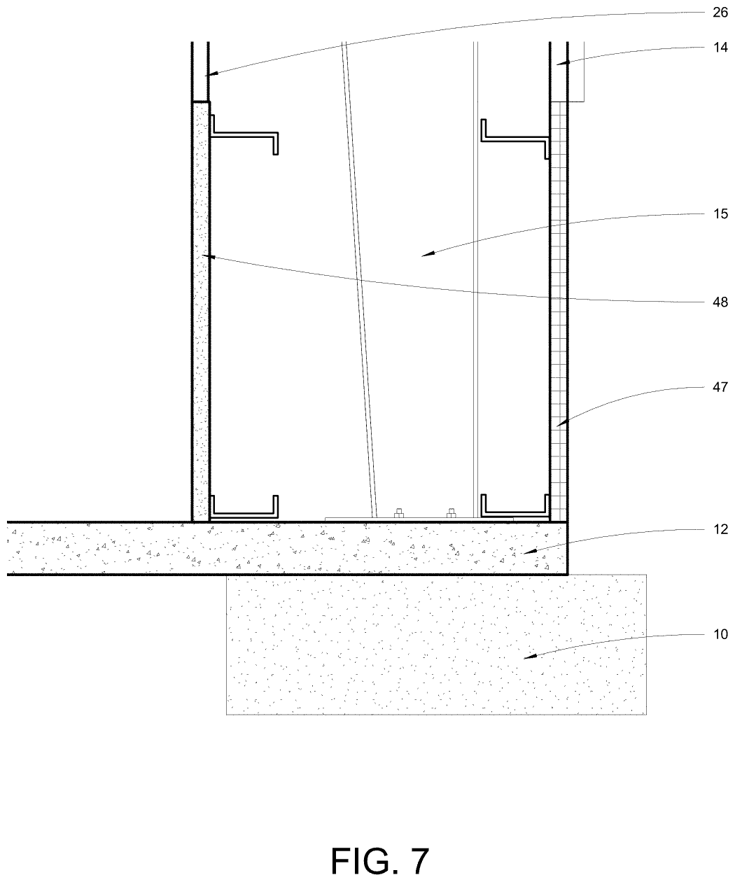

FIGS. 3-7 show how the standard industrial metal building of the type shown in FIG. 2 can be modified, adapted, or converted into an effective, functional hybrid greenhouse. The terms “panel” or “panels” are used herein to refer generally to the planar walls, roof, and ceiling coverings for the column, joist, and girder structural elements. Rather than panels, the walls, roof, and ceiling could be formed of large, continuous sheets that might not be thought of as several panels.

Walls 13 replace the outside walls of the known building with light transmissive weatherized panels 14, which can be made of polycarbonate material or any other material having the proper characteristics to function as an outside wall and also transmit external light (daylight). They should be relatively rigid, that is, they can stand against a wall and remain upright.

Inside walls 18, composed of wall panels 26, are then mounted on the inside of wall support elements 15. Wall panels 14 and 26 are thus spaced, defining chamber or cavity 27 therebetween. It is contemplated that all four walls (assuming a rectangular building structure) will be constructed to define a continuous similar chamber or cavity. However, they may be separate chambers in fluid communication.

The normally opaque roof panels are replaced by light transmissive outside panels 31, which may also be made of polycarbonate material or other material having the necessary strength and light transmissive properties to function as a roof and to admit appropriate light into the greenhouse.

On the inside of roof structure 17 are mounted inside ceiling panels 32, which may be made of the same material as are roof panels 31. Since ceiling panels 32 do not have to have the same strength requirements as do roof panels 31, they need not be made of the same material or have the same thickness or stiffness.

Panels 31 and 32 are spaced apart and define cavity 33 therebetween. They may be referred to as outside and inside top panels, respectively.

It is preferred that cavities 27 and 33 are sealed to outside air and are in fluid communication in a continuous sealed channel complex. In particular, while each cavity (wall and roof/ceiling) could be generally separate, they are intended to be open internal channels for the same air or gas supply. They could all be in open communication, or each channel or cavity could be separately sealed and be subject to the same air or gas from outside sources. Thus, unit 35 (FIG. 3) could be a heat pump or an air conditioner, or both. Unit 35 could have a single location and supply the desired fluid at the appropriate temperature directly through a coupling in a wall panel 14 or concrete pad 12 to supply the fluid to the entire cavity complex.

Alternatively, there could be several units 35, or one unit 35 could have several conduits coupled separately to cavities 27 and 33.

Another external unit 41 can be employed to supply the desired fluid (air or gas, or both) to the interior 42 of the greenhouse.

The spacing of respective walls panels 14, 26 and roof/ceiling panels 31, 32 is only that necessary to accommodate the building structural elements and to provide sufficient space to enable fluid flow of air or gases in the wall and roof chambers. That spacing could be as little as eight to ten inches and as large as 2.5 feet, and these are only practical spacings and are not limits. Further, cavities 27 need not have the same width or spacing as cavities 33.

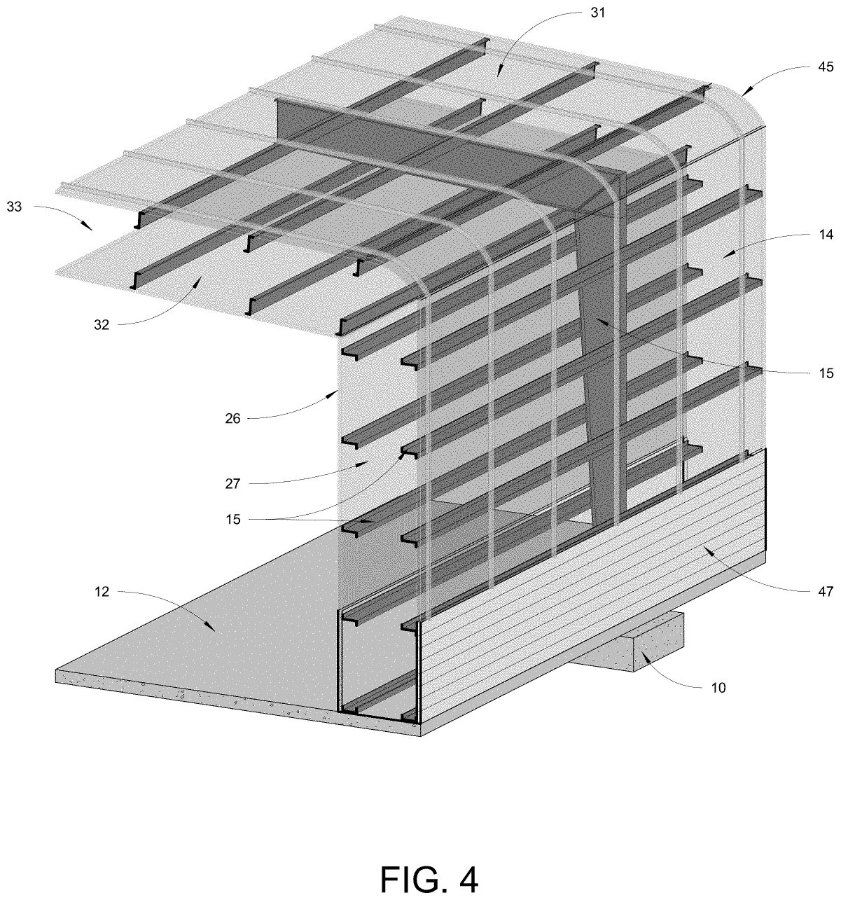

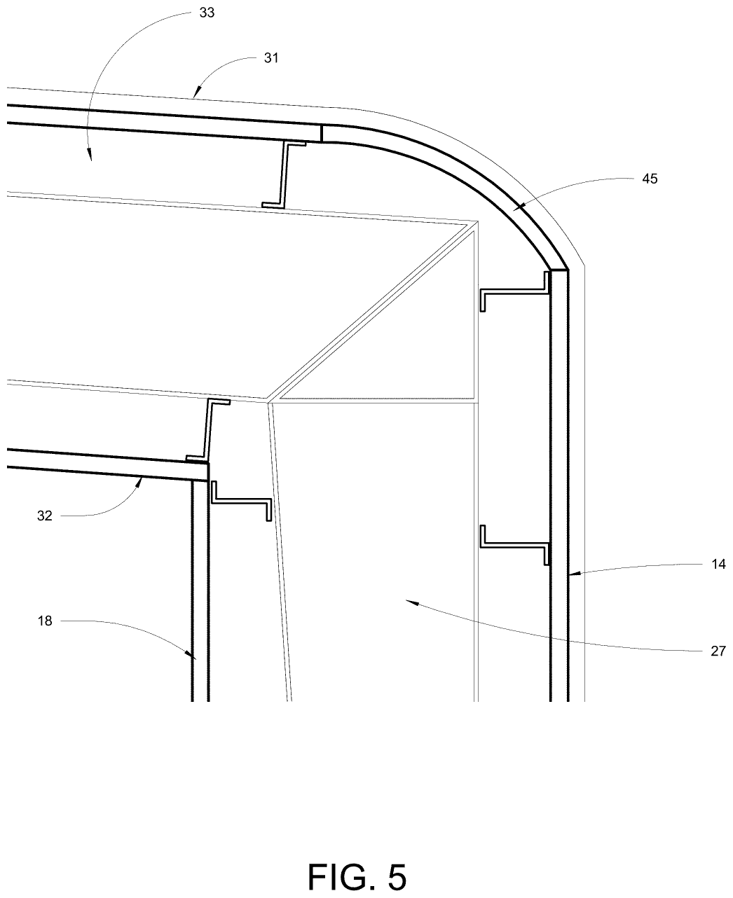

With reference to FIGS. 4 and 5, cavities 27 and 33 are connected for fluid flow by means of a radius eave coupling 45 which facilitates fluid flow from cavity 27 to cavity 33 and vice versa. Coupling 45 may be made of the same material as are the walls and roof/ceiling. However, the function of air/gas coupling of the wall and roof chambers is to permit fluid flow so it is not required that it be light transmissive. Roof panels 31 may transition to external wall panels 14 if desired.

While the concept focuses on a novel greenhouse structure, the resulting building could be used for any function, use, or purpose. It provides a controlled environment that is particularly useful as a greenhouse, which does not prevent the building from being used for other purposes.

What is claimed is:

1. A hybrid greenhouse having as its base structure the skeleton of an industrial metal building of column, girder, and joist construction mounted on foundation or pad, the overhead of the metal building being a truss structure, the greenhouse comprising:
external wall panels secured to vertical columns of the base structure;
internal wall panels secured to an opposite side of the vertical columns, said external and internal wall panels being spaced from each other, thereby defining a wall cavity between external and internal walls formed by said external and internal wall panels;
external roof panels secured to the overhead truss structure of the base structure;
internal ceiling panels secured to the overhead truss structure of the base structure in spaced relationship from said external roof panels, thereby defining a ceiling cavity between said external roof panels and said internal ceiling panels; and
means for coupling said wall cavity and said ceiling cavity for fluid flow therebetween.

2. The greenhouse of claim 1, wherein said external wall panels are light transmissive panels and said internal wall panels are light transmissive panels.

3. The greenhouse of claim 2, wherein said external and internal wall panels are formed of a polycarbonate material.

4. The greenhouse of claim 1, wherein said external roof panels are light transmissive panels and said internal ceiling panels are light transmissive panels.

5. The greenhouse of claim 4, wherein said external and internal roof panels are formed of a polycarbonate material.

6. The greenhouse of claim 1, wherein said means for coupling said wall cavity to said ceiling cavity for fluid flow therebetween is a radius eave.

7. The greenhouse of claim 1, wherein the wall cavity and the ceiling cavity provide insulation value to the greenhouse.
